(19) United States
(12) Patent Application Publication
(10) Pub. No.: US 2025/0172419 A1
(43) Pub. Date: May 29, 2025

(54) WIRELESS SENSOR RELAY

(71) Applicant: Smart Rain Systems, LLC, Bountiful, UT (US)

(72) Inventor: Rudy Lars Larsen, Bountiful, UT (US)

(21) Appl. No.: 18/962,860

(22) Filed: Nov. 27, 2024

Related U.S. Application Data
(60) Provisional application No. 63/603,520, filed on Nov. 28, 2023.

(51) Int. Cl. G01F 1/002; G01F 15/06; G01F 15/063; G08C 17/02

(52) U.S. Cl. CPC G01F 1/002; G01F 15/063; G01F 15/065; G08C 17/02

(57) ABSTRACT

A signal relay may include sensor leads configured to be communicatively coupled to sensor leads of said flow sensor, wherein the sensor leads are configured to connect to a plurality of different flow sensors. A signal relay may include memory in communication with the sensor leads, the memory configured to store measurements from said flow sensor. A signal relay may include a wireless transmitter configured to transmit the measurements to a remote computing device.

### CROSS-REFERENCE TO RELATED APPLICATIONS

This application claims priority to and benefit of U.S. Provisional Patent Application No. 63/603,520, filed Nov. 28, 2023, the disclosure of which is incorporated herein by reference in its entirety.

### BACKGROUND

Irrigation systems provide water to plants from a main water line, or water main. The water main has a capacity, which is typically measured in terms of a volumetric flow rate, such as gallons per minute (GPM). The water main capacity may be measured using other hydraulic parameters, such as pressure. Some irrigation systems may use one or more irrigation devices, such as a sprinkler head. These may help to deliver the irrigation water over an area. In some situations, the watering area to be irrigated (or watered) may utilize more water than is available from the water main. To water the entire watering area, an irrigation operator may separate this area into two or more zones. The irrigation devices in the zones may be connected to the water main through a valve. The valve may be opened and closed using an irrigation controller. In some situations, the irrigation devices may include flow sensors to measure one or more soil properties.

### BRIEF SUMMARY

In some aspects, the techniques described herein relate to a sensor relay for a flow sensor installed in an irrigation system. The sensor relay includes sensor leads configured to be communicatively coupled to sensor leads of said flow sensor. The sensor leads are configured to connect to a plurality of different flow sensors. The sensor relay includes memory in communication with the sensor leads. The memory is configured to store measurements from said flow sensor. A wireless transmitter is configured to transmit the measurements to a remote computing device.

In some aspects, the techniques described herein relate to a method for monitoring a flow sensor installed in an irrigation system. The sensor relay receives a signal from the flow sensor. The sensor relay is communicatively coupled to sensor leads of the flow sensor. The sensor leads are configured to connect to a plurality of different flow sensors. The sensor relay stores the signal on memory at the sensor relay. The sensor relay wirelessly transmits the signal to a remote computing device.

This summary is provided to introduce a selection of concepts that are further described below in the detailed description. This summary is not intended to identify key or essential features of the claimed subject matter, nor is it intended to be used as an aid in limiting the scope of the claimed subject matter. Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a representation of a cloud-based irrigation system, according to at least one embodiment of the present disclosure.

FIG. 2 is a representation of a flow sensor system according to at least one embodiment of the present disclosure.

FIG. 3 is a schematic representation of a wireless sensor relay, according to at least one embodiment of the present disclosure.

FIG. 4 is a flowchart of a method for monitoring a flow sensor installed in an irrigation system, according to at least one embodiment of the present disclosure.

FIG. 5 is a flowchart of a method for monitoring a flow sensor installed in an irrigation system, according to at least one embodiment of the present disclosure.

FIG. 6 is a schematic representation of a computing system, according to at least one embodiment of the present disclosure.

### DETAILED DESCRIPTION

This disclosure generally relates to devices, systems, and methods for a universal wireless relay for a flow sensor in an irrigation system. The wireless relay include relay leads (e.g., wires) that may be connected to sensor leads (e.g., wires) of the flow sensor. The flow sensor may be any type of flow sensor from any manufacturer. When the flow sensor senses a threshold level of flow, the wireless relay may wirelessly transmit the measurement to a remote computing device. For example, the wireless relay may wirelessly transmit the measurement to a wireless irrigation controller, a cloud-based irrigation controller, a mobile device, a local area network, a server, any other remote computing device, and combinations thereof. Utilizing a wireless relay may facilitate faster and/or more reliable communication of flow information to the irrigation manager. This may facilitate faster identification of the presence of leaks, the severity of leaks, faulty valves, inadvertent opening of valves, any other flow information, and combinations thereof.

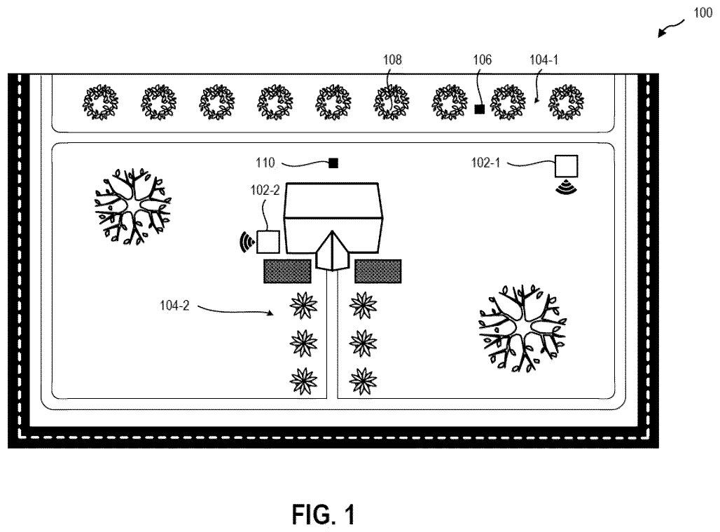

FIG. 1 is a representation of a cloud-based irrigation system 100, according to at least one embodiment of the present disclosure. The cloud-based irrigation system 100 includes a plurality of irrigation controllers (collectively 102). The irrigation controllers 102 may control the watering for a watering area. The watering area may include one or more watering zones (collectively 104). Each watering zone may include one or more irrigation devices 106. The irrigation devices 106 may provide water to one or more plants 108. The irrigation devices 106 may include any type of irrigation device, such as a spray head, a rotary head, a drip irrigation device, any other type of irrigation device, and combinations thereof. In some embodiments, an irrigation device 106 may water a single plant 108. In some embodiments, an irrigation device 106 may provide water to multiple plants 108. The plants 108 may include any type of plant, such as grass, shrubs, flowers, trees, garden plants, crops, any other type of plant, and combinations thereof.

Different irrigation controllers 102 may provide water to different irrigation zones 104. For example, a first irrigation controller 102-1 may control the irrigation to a first zone 104-1 and a second irrigation controller 102-2 may control the irrigation to a second zone 104-2. While two irrigation controllers 102 are shown each controlling a single zone 104, it should be understood that the watering area may include any number of irrigation controllers 102 watering any number of zones 104. For example, a single irrigation controller 102 may control 48 zones or any number of zones.

The irrigation controllers 102 may include any type of irrigation controller. For example, the irrigation controllers 102 may include a single-wire irrigation controller, with multiple valves or other irrigation devices connected to a single common wire. In some examples, the irrigation controllers 102 may include a “two-wire controller.” A two-wire controller may connect multiple valves or other irrigation devices in series. A two-wire controller may allow for an increased number of connected valves. In some embodiments, the irrigation controllers 102 may include a wireless irrigation controller. For example, the irrigation controllers 102 may wirelessly connect to the valves and other connected irrigation devices. In some embodiments, the irrigation controllers 102 may include any type of irrigation controller connected to one or more valves in any way, including wired connections having any configuration, wireless connections, and combinations thereof. In some embodiments, the cloud-based irrigation system 100 may include multiple types of irrigation controllers 102.

The irrigation controllers 102 may include local irrigation programs for their associated zones 104. In some embodiments, an irrigation program may include a time of day to water for a particular zone 104 and/or set of zones 104. In some embodiments, an irrigation program may include a duration to water for a particular zone 104 and/or set of zones 104. In some embodiments, an irrigation program may include times during which to collect irrigation conditions from one or more sensors 110, as discussed herein. In some embodiments, the irrigation program may be a local irrigation program associated with the particular irrigation controller 102. In some embodiments, a local irrigation program may include controls for any other operation or combinations of operations performed by the irrigation controller 102.

In some embodiments, a single zone 104 may utilize all of the water provided by a water main. In some embodiments a single zone 104 may utilize a portion of the water provided by the water main. A zone 104 may be provided for a group of plants having similar watering patterns. In some examples, the zone 104 may be provided for a group of the same plant. In some embodiments, the zone 104 may be provided based on the capacity of the water main and the water usage of the irrigation devices 106. For example, a grassy field may include multiple zones 104, each of which max out the water main.

In some embodiments, selecting which zones 104 are simultaneously actuated may be referred to as “stacking” the irrigation system. Stacking the zones 104 may be based on any irrigation factor. For example, the zones 104 may be stacked to use all or most of the available water supply from the water main. This may result in zones 104 that are not adjacent to each other to be part of the same stack. In some examples, stacked zones 104 may have the same irrigation duration. In some examples, stacked zones 104 may have different durations. This may result in a first zone being actuated while a second zone is still running. In this manner, different zones having different durations may be stacked to reduce the opportunity costs of lost water supply from the water main.

In some embodiments, a stack may be a cross-controller stack that include two zones 104 associated with different irrigation controllers 102. For example, the first zone 104-1 and the second zone 104-2 may be simultaneously actuated as part of the same stack. Actuating zones 104 from different irrigation controllers 102 may allow the irrigation operator to utilize all of the water supply from the water main.

The cloud-based irrigation system 100 may include one or more sensors 110. The sensors 110 may detect irrigation conditions of the cloud-based irrigation system 100. For example, the sensors 110 may detect irrigation conditions of plants and/or soil in the watering area. For example, the sensors 110 may detect soil moisture, soil pH, soil chemistry, and other irrigation conditions of the plants and/or soil in the watering area. In some examples, the sensors 110 may detect flow rate information for one or more of the zones 104 and/or irrigation devices 106. In some examples, the sensors 110 may detect pressure information for one or more of the zones 104 and/or irrigation devices 106. In some examples, the sensors 110 may collect weather information. For example, the sensors 110 may detect temperature, humidity, rainfall, wind speed, wind direction, barometric pressure, any other weather information, and combinations thereof. In some embodiments, the sensors 110 may collect photographic information of all or a portion of the watering area. For example, the sensors 110 may collect photos of a patch of grass or plants. Plants may change colors based on over-watering, under-watering, nutrient levels, the presence of pests, the presence of weeds, temperature, any other condition, and combinations thereof.

In some embodiments, the sensors 110 may be in communication with the irrigation controllers 102. For example, one or more of the sensors 110 may be located within a zone associated with a particular irrigation controller 102, and the sensors 110 may be in communication (e.g., wired or wireless communication) with the irrigation controller 102. Put another way, the sensors 110 may communicate (e.g., wired or wirelessly) with the irrigation controllers 102. In some embodiments, the sensors 110 may receive power from the associate irrigation controller 102.

In accordance with at least one embodiment of the present disclosure, at least one of the sensors 110 may include a water flow sensor (or, as used herein, a “flow sensor”). The flow sensor may be installed in a water pipe of the irrigation system. The flow sensor may sense the flow of water through the water pipe. In some embodiments, the flow sensor may quantify the flow of water through the water pipe. For example, the flow sensor may prepare an amount of flow through the pipe in gallons per minute (GPM), cubic feet per second (cfs), cubic meters per hour, or other flow rate.

Conventionally, a flow sensor may be wired to an irrigation controller 102. For example, the flow sensor may be located proximate to the irrigation controller 102 with one or more wire leads extending to the irrigation controller 102. In this manner, the irrigation controller 102 may directly receive the flow rate data from the flow sensor.

In some situations, it may be desirable for the flow sensor to be located away from the irrigation controllers 102. This may allow the flow sensor to detect the flow rate of water through the pipe at remote locations not feasible for a wired connection between the flow sensor and irrigation controller 102. The flow sensor may be located at any location. For example, the flow sensor may be located to measure the flow rate of the irrigation zone 104 associated with an irrigation controller 102. In some examples, the flow sensor may be located to measure the flow rate of water flowing to a particular irrigation zone 104 or set of irrigation zones. In some examples, the flow sensor may be located to measure the flow rate of water flowing to a particular irrigation device 106 or set of irrigation devices 106. The flow sensor may measure the flow rate at any location relative to a particular irrigation element. For example, the flow sensor may be located upstream or downstream of the irrigation element.

The flow sensor may provide various types of information to the irrigation operator. For example, the flow rate information of the flow sensor may allow the irrigation operator to determine whether a valve is open, whether a valve is leaking, how big a leak is, whether an irrigation element is broken (e.g., blocked and using less water, damaged and using more water), any other irrigation information, and combinations thereof.

In accordance with at least one embodiment of the present disclosure, the cloud-based irrigation system 100 may include a wireless relay for the flow sensor. The wireless relay may be connected to the flow sensor. The wireless relay may receive the measurements from the flow sensor and transmit the measurements to a remote computing device. For example, the wireless relay may receive the measurements from the flow sensor and transmit the measurements to one or more of the irrigation controllers 102. This may allow the irrigation controllers 102 to determine when water is flowing through the pipe at which the flow sensor is located.

In accordance with at least one embodiment of the present disclosure, the wireless relay may be agnostic to the make, model, or type of the flow sensor. For example, the wireless relay may include relay leads. The relay leads may extend from the wireless sensor. The flow sensor may include sensor leads. The relay leads may connect to the sensor leads. When the flow sensor senses a flow of water through the pipe, the flow sensor may send a measurement signal through the sensor leads. The wireless relay may receive the measurement signal from the sensor leads. The wireless relay may then transmit the measurement signal to the remote computing device. In this manner, the wireless relay may provide flow rate information to the remote computing device from a flow sensor location that is remote to the irrigation controllers 102.

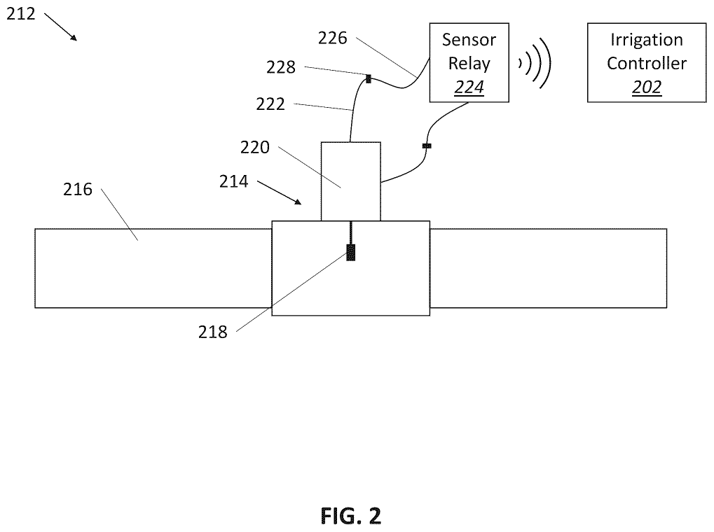

FIG. 2 is a representation of a flow sensor system 212 according to at least one embodiment of the present disclosure. In the flow sensor system 212 shown, a flow sensor 214 is installed in-line on a pipe 216. Water may flow through the pipe 216. As discussed herein, the pipe 216 may be at any location within the irrigation system. The pipe 216 may have any pipe diameter. For example, the pipe diameter may be 0.25 in. (0.64 cm), 0.5 in. (1.27 cm), 0.75 in. (1.91 cm), 1.0 in. (2.54 cm), 1.25 in. (3.18 cm), 1.5 in. (3.81 cm), 2.0 in. (5.08 cm), 2.5 in. (6.35 cm), 3.0 in. (7.62 cm), 3.5 in. (8.89 cm), 4.0 in. (10.2 cm), 5.0 in. (12.7 cm), 6.0 in. (15.2 cm), greater than 6.0 in. or any value therebetween.

The flow sensor 214 may be any type of flow sensor. For example, the flow sensor 214 may be a paddle flow sensor, having a paddle 218. As water flows through the pipe 216, the water may push on the paddle 218, causing the paddle 218 to rotate. The rate of rotation of the paddle 218 may be associated with the flow rate of the water through the pipe 216. While a paddle-wheel style flow sensor is illustrated and described herein, it should be understood that any type of flow sensor may be used in accordance with at least one embodiment of the present disclosure, including differential pressure sensors, magneto-inductive, venturi tube, orifice plate, sonic, any other type of flow sensor, and combinations thereof.

The flow sensor 214 may include a sensor housing 220. The sensor housing 220 may include space for wheels of the paddle 218 to rotate. The sensor housing 220 may include a rotational speed sensor, such as a magnetic sensor, an optical sensor, an inductive current sensor, any other rotational speed sensor, and combinations thereof. Electronics in the sensor housing 220 may measure the rotational speed of the paddle 218. As discussed herein, the rotational speed of the paddle 218 may be used to determine the flow rate of the water in the pipe 216.

The flow sensor 214 may include sensor leads 222. The sensor leads 222 may be connected to the paddle 218 and/or electronics in the sensor housing 220. The sensor leads 222 may carry the measurement signal generated by the rotation of the paddle 218 and/or the electronics that process the rotation of the paddle 218. While the sensor leads 222 are illustrated in FIG. 2 as wires extending from the sensor housing 220, it should be understood that the sensor leads 222 may be any type of lead, such as a port into which wires may be inserted.

The flow sensor system 212 includes a sensor relay 224. The sensor relay 224 may include relay leads 226. The relay leads 226 may connect or be coupled to the sensor leads 222 at a lead connection 228. The relay leads 226 may be coupled to the sensor leads 222 with any manner of coupling or connection. For example, the relay leads 226 may be coupled to the sensor leads 222 by twisted wires. In some examples, the relay leads 226 may be coupled to the sensor leads using a coaxial connection. This may allow the measurement signal from the sensor housing 220 to be passed to the sensor relay 224 through the sensor leads 222 and the relay leads 226.

The sensor relay 224 may receive the measurement signal. In accordance with at least one embodiment of the present disclosure, the sensor relay 224 may include a wireless antenna. The wireless antenna may wirelessly transmit the measurement signal to a remote computing device, such as an irrigation controller 202. The irrigation controller 202 may receive the wireless transmission of the measurement signal. In this manner, the flow sensor system 212 may provide the irrigation controller 202 with flow rate information from a flow sensor 214 located remote from the irrigation controller 202.

As discussed herein, the sensor relay 224 may be agnostic to the type, make, model, or other identifying elements of the flow sensor 214. For example, the sensor relay 224 may be a universal relay, and may be configured to connect or be connected to any flow sensor 214. For example, the sensor relay 224 may be connected to a third-party flow sensor 214. In some examples, the sensor relay 224 may pass the measurement signal to the irrigation controller 202 without processing the measurement signal. This may allow the sensor relay 224 to relay the measurement signal without decoding or deciphering the signal from the flow sensor 214.

In some embodiments, the flow sensor 214 may at least partially process the measurement signal from the rotational rate of the paddle 218. For example, the flow sensor 214 may prepare a flow rate from the rotational rate of the paddle 218. In some examples, the flow sensor 214 may prepare an average flow rate from the rotational rate of the paddle 218 over a period of time. In some embodiments, the flow sensor 214 may transmit the processed measurement signal to the sensor relay 224. In some embodiments, the flow sensor 214 transmit the raw measurement signal to the sensor relay 224.

In some embodiments, the sensor relay 224 may relay the measurement signal to the irrigation controller 202 without processing the measurement signal. The irrigation controller 202 may then process the measurement signal to determine the flow rate and/or information related to the flow rate.

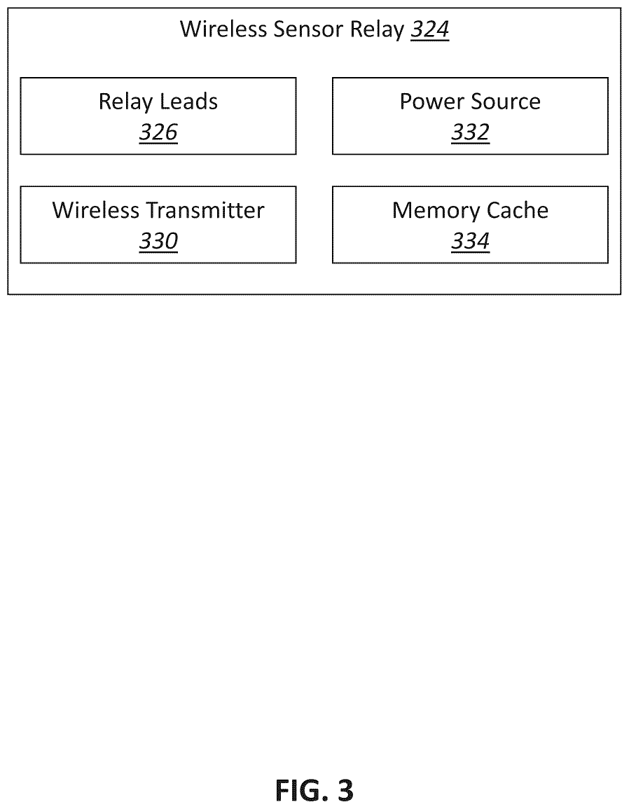

FIG. 3 is a schematic representation of a wireless sensor relay 324, according to at least one embodiment of the present disclosure. Each of the components of the wireless sensor relay 324 can include software, hardware, or both. For example, the components can include one or more instructions stored on a computer-readable storage medium and executable by processors of one or more computing devices, such as a client device or server device. When executed by the one or more processors, the computer-executable instructions of the wireless sensor relay 324 can cause the computing device(s) to perform the methods described herein. Alternatively, the components can include hardware, such as a special-purpose processing device to perform a certain function or group of functions. Alternatively, the components of the wireless sensor relay 324 can include a combination of computer-executable instructions and hardware.

Furthermore, the components of the wireless sensor relay 324 may, for example, be implemented as one or more operating systems, as one or more stand-alone applications, as one or more modules of an application, as one or more plug-ins, as one or more library functions or functions that may be called by other applications, and/or as a cloud-computing model. Thus, the components may be implemented as a stand-alone application, such as a desktop or mobile application. Furthermore, the components may be implemented as one or more web-based applications hosted on a remote server. The components may also be implemented in a suite of mobile device applications or “apps.”

The wireless sensor relay 324 may include relay leads 326. The relay leads 326 may be used to connect to the wireless relay. In some embodiments, the relay leads 326 may include wires that may be connected to sensor leads on the flow sensor. In some embodiments, the relay leads 326 may include wires that may be connected to a port or other connector at the flow sensor. The wireless sensor relay 324 may receive the measurement signal from the flow sensor through the relay leads 326.

The wireless sensor relay 324 may include a wireless transmitter 330. The wireless transmitter 330 may wirelessly transmit the measurement signal to a remote computing device. The wireless transmitter 330 may include any type of wireless transmitter. For example, the wireless transmitter 330 may transmit using the long range (LoRa) transmission protocol (e.g., the wireless transmitter 330 may be a LoRa protocol wireless transmitter). In some examples, the wireless transmitter 330 may transmit using Wi-Fi transmission protocol, Bluetooth transmission protocol, Zigbee transmission protocol, radio transmission protocol, any other transmission protocol, and combinations thereof.

The wireless sensor relay 324 may include an independent power source 332. The independent power source 332 may provide power to the elements of the wireless sensor relay 324. For example, the independent power source 332 may provide power to the wireless transmitter 330 to transmit the measurement signals to the irrigation operator. The independent power source 332 may increase the operational independence of the wireless sensor relay 324. This may allow the wireless sensor relay 324 to be placed in locations that do not have convenient or any access to wired power lines.

In some embodiments, the independent power source 332 is connected to a power generation system. For example, the independent power source 332 may be connected to a solar cell charging element located on the housing of the wireless sensor relay 324. This may allow the independent power source 332 to be charged without disconnecting the wireless sensor relay 324 from the flow sensor and/or otherwise physically engaging with the wireless sensor relay 324.

The independent power source 332 may transition the wireless sensor relay 324 between a hibernation mode and a transmission mode. In the hibernation mode, the wireless sensor relay 324 may consume a small amount of power. This may help to extend the operational lifetime. In the transmission mode, the wireless sensor relay 324 may provide power to the wireless transmitter 330 to prepare the transmission of the measurement signal.

In accordance with at least one embodiment of the present disclosure, the wireless sensor relay 324 may include a memory cache 334. The memory cache 334 may receive the measurement signals and store the measurement signals. In some embodiments, the memory cache 334 temporarily stores the measurement signals. For example, the memory cache 334 may store the measurement signals until a threshold number of measurement signals are stored. In some examples, the memory cache 334 may store the measurement signals until the wireless transmitter 330 transmits the measurement signals.

In some embodiments, the memory cache 334 stores the measurement signals until a threshold signal is reached. For example, the memory cache 334 may monitor the measurement signals until a measurement signal is received that exceeds the threshold signal. When the memory cache 334 receives the measurement signal that exceeds the threshold signal, the wireless transmitter 330 may transmit all of the measurement signals in the memory cache 334. The threshold signal may be representative of any type of threshold. For example, the threshold signal may be representative of the measurement signal associated with a leak in the irrigation system. In some examples, the threshold signal may be associated with an open valve of the irrigation system.

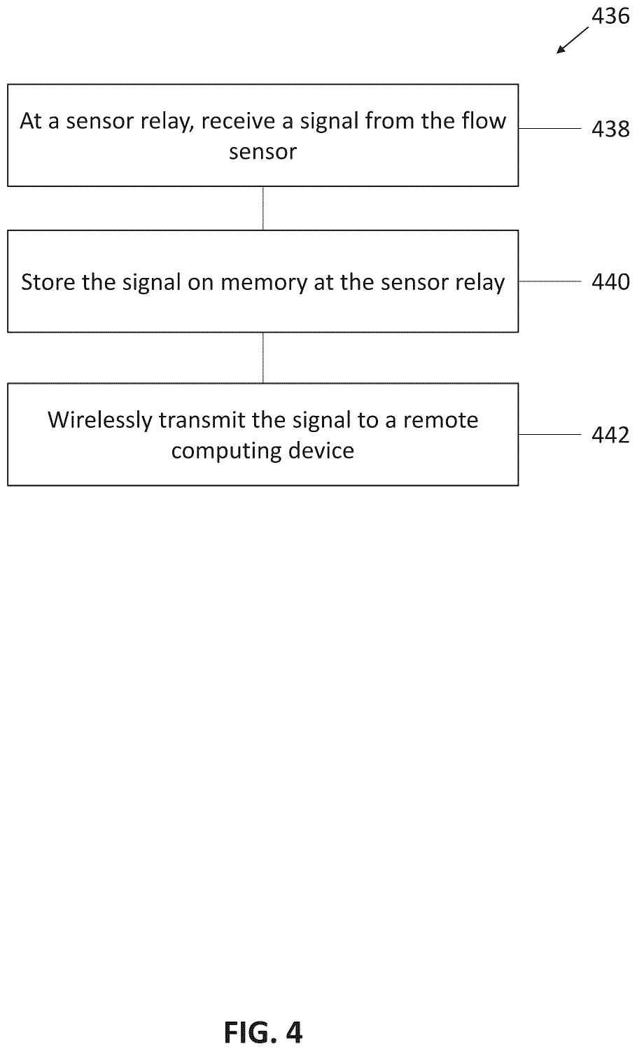

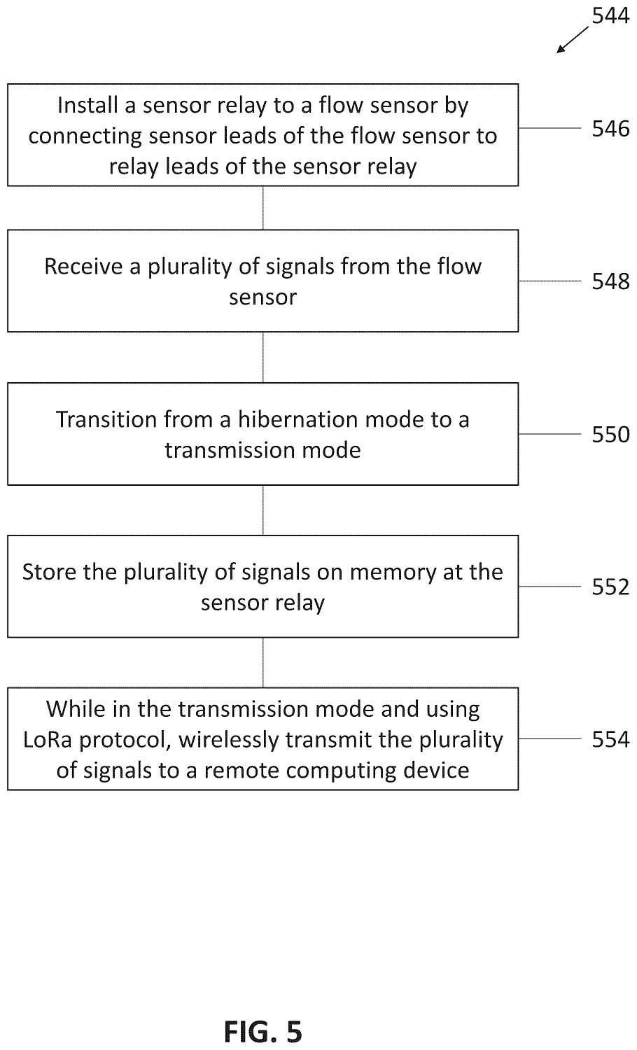

FIGS. 4 and 5, the corresponding text, and the examples provide a number of different methods, systems, devices, and computer-readable media of the flow sensor system 212. In addition to the foregoing, one or more embodiments can also be described in terms of flowcharts comprising acts for accomplishing a particular result, as shown in FIGS. 4 and 5. FIGS. 4 and 5 may be performed with more or fewer acts. Further, the acts may be performed in differing orders. Additionally, the acts described herein may be repeated or performed in parallel with one another or parallel with different instances of the same or similar acts.

As mentioned, FIG. 4 illustrates a flowchart of a series of acts or a method 436 for monitoring a flow sensor installed in an irrigation system, according to at least one embodiment of the present disclosure. While FIG. 4 illustrates acts according to one embodiment, alternative embodiments may omit, add to, reorder, and/or modify any of the acts shown in FIG. 4. The acts of FIG. 4 can be performed as part of a method. Alternatively, a computer-readable medium can comprise instructions that, when executed by one or more processors, cause a computing device to perform the acts of FIG. 4. In some embodiments, a system can perform the acts of FIG. 4.

A wireless sensor relay may receive a signal from a flow sensor at 438. The sensor relay may be communicatively coupled to sensor leads of the flow sensor. The sensor leads are configured to connect to a plurality of different flow sensors. The plurality of different flow sensors may include different make and/or different models of flow sensors. The plurality of different flow sensors may include different types of flow sensors (e.g., flow sensors having a different sensing mechanism). In some embodiments, the wireless relay is installed to the flow sensor by coupling the sensor leads of the flow sensor to relay leads of the sensor relay.

The wireless sensor relay may store the signal on memory at the sensor relay at 440. The wireless sensor relay may wirelessly transmit the signal to a remote computing device at 442. In some embodiments, wirelessly transmitting the signal includes wirelessly transmitting the signal using LoRa protocol.

In some embodiments, the memory includes a memory cache. In some embodiments, the wireless relay clears the memory cache after wirelessly transmitting the signal.

In some embodiments, the wireless relay includes a transmission mode and a hibernation mode. In the hibernation mode, the wireless relay may monitor for any incoming signals from the flow sensor. In the transmission mode, the wireless relay may transmit the signal to the remote computing device. In some embodiments, the wireless relay transitions from the hibernation mode to the transmission mode when the signal exceeds a threshold signal. In some embodiments, the threshold signal is associated with a flow rate associated with a leak at a valve upstream of the flow sensor.

In some embodiments, the signal includes a plurality of signals. The wireless relay may store the plurality of signals in the memory when the plurality of signals have a signal below the threshold signal. In some embodiments, the wireless relay transmits the plurality of signals when at least one of the plurality of signals exceeds the threshold signal.

As mentioned, FIG. 5 illustrates a flowchart of a series of acts or a method 544 for monitoring a flow sensor installed in an irrigation system, according to at least one embodiment of the present disclosure. While FIG. 5 illustrates acts according to one embodiment, alternative embodiments may omit, add to, reorder, and/or modify any of the acts shown in FIG. 5. The acts of FIG. 5 can be performed as part of a method. Alternatively, a computer-readable medium can comprise instructions that, when executed by one or more processors, cause a computing device to perform the acts of FIG. 5. In some embodiments, a system can perform the acts of FIG. 5.

An irrigation operator may install a sensor relay to a flow sensor at 546. The sensor relay may be installed by connecting sensor leads of the flow sensor to relay leads of the sensor relay. As discussed herein, the sensor leads are configured to connect to a plurality of different flow sensors. The sensor relay may be powered by an independent power source.

The sensor relay may receive a plurality of signals from the flow sensor at 548. The plurality of signals may be associated with a rotational rate of a paddle of the flow sensor. The sensor relay may transition from a hibernation mode to a transmission mode at 550. The sensor relay may store the plurality of signals on memory at the sensor relay 552. While in the transmission mode, and using LoRa protocol, the sensor relay may wirelessly transmit the plurality of signals to a remote computing device.

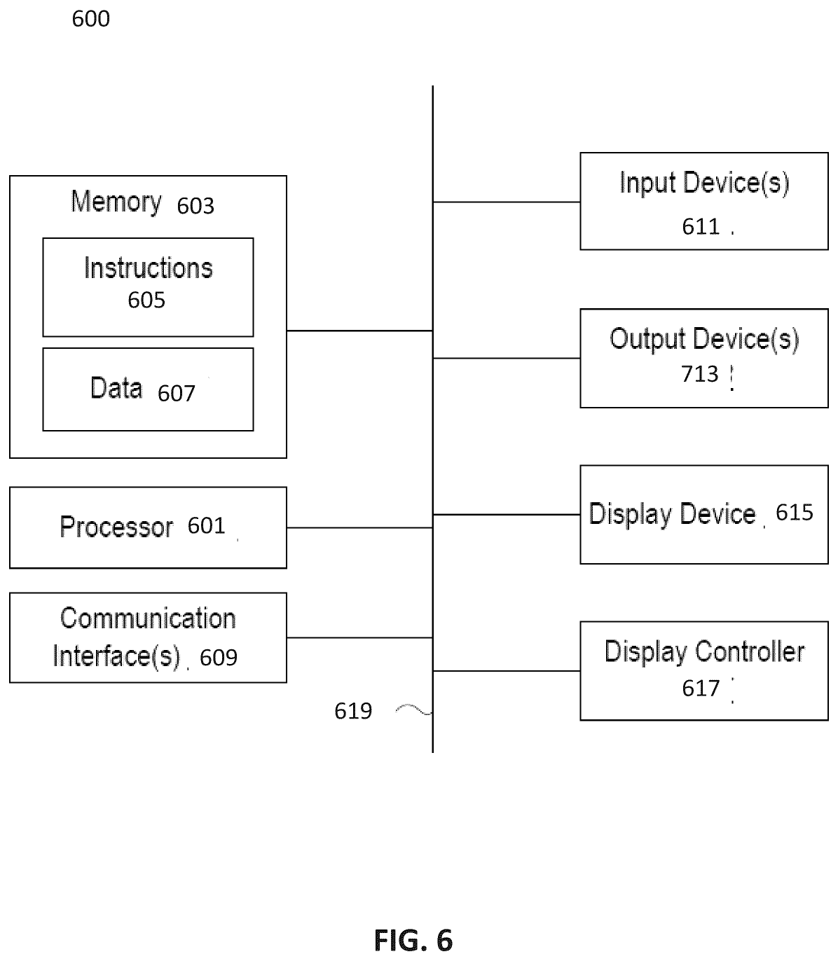

FIG. 6 illustrates certain components that may be included within a computer system 600. One or more computer systems 600 may be used to implement the various devices, components, and systems described herein.

The computer system 600 includes a processor 601. The processor 601 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 601 may be referred to as a central processing unit (CPU). Although just a single processor 601 is shown in the computer system 600 of FIG. 6, in an alternative configuration, a combination of processors (e.g., an ARM and DSP) could be used.

The computer system 600 also includes memory 603 in electronic communication with the processor 601. The memory 603 may be any electronic component capable of storing electronic information. For example, the memory 603 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 605 and data 607 may be stored in the memory 603. The instructions 605 may be executable by the processor 601 to implement some or all of the functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor 601. Any of the various examples of data described herein may be among the data 607 that is stored in memory 603 and used during execution of the instructions 605 by the processor 601.

A computer system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 600 may also include one or more input devices 611 and one or more output devices 613. Some examples of input devices 611 include a keyboard, mouse, microphone, remote control device, button, joystick, trackball, touchpad, and lightpen. Some examples of output devices 613 include a speaker and a printer. One specific type of output device that is typically included in a computer system 600 is a display device 615. Display devices 615 used with embodiments disclosed herein may utilize any suitable image projection technology, such as liquid crystal display (LCD), light-emitting diode (LED), gas plasma, electroluminescence, or the like. A display controller 617 may also be provided, for converting data 607 stored in the memory 603 into text, graphics, and/or moving images (as appropriate) shown on the display device 615.

The various components of the computer system 600 may be coupled together by one or more buses, which may include a power bus, a control signal bus, a status signal bus, a data bus, etc. For the sake of clarity, the various buses are illustrated in FIG. 6 as a bus system 619.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A sensor relay for a flow sensor installed in an irrigation system, the sensor relay comprising:
sensor leads configured to be communicatively coupled to sensor leads of said flow sensor, wherein the sensor leads are configured to connect to a plurality of different flow sensors;
memory in communication with the sensor leads, the memory configured to store measurements from said flow sensor; and
a wireless transmitter configured to transmit the measurements to a remote computing device.

2. The sensor relay of claim 1, wherein plurality of flow sensors includes a first flow sensor and a second flow sensor, and wherein the first flow sensor is a different model than the second flow sensor.

3. The sensor relay of claim 1, wherein plurality of flow sensors includes a first flow sensor and a second flow sensor, and wherein the first flow sensor is a different type than the second flow sensor.

4. The sensor relay of claim 1, wherein the wireless transmitter is a long range (LoRa) protocol wireless transmitter.

5. The sensor relay of claim 1, wherein the memory includes a memory cache.

6. The sensor relay of claim 1, further comprising a power source configured to power the sensor leads, the memory, and the wireless transmitter.

7. The sensor relay of claim 6, further comprising a solar cell configured to provide power to the power source.

8. A method for monitoring a flow sensor installed in an irrigation system, the method comprising:
at a sensor relay, receiving a signal from the flow sensor, the sensor relay communicatively coupled to sensor leads of the flow sensor, wherein the sensor leads are configured to connect to a plurality of different flow sensors;
storing the signal on memory at the sensor relay; and
wirelessly transmitting the signal to a remote computing device.

9. The method of claim 8, further comprising installing the sensor relay to the flow sensor by coupling the sensor leads of the flow sensor to relay leads of the sensor relay.

10. The method of claim 9, wherein the flow sensor is a first flow sensor and further comprising:
disconnecting the sensor relay from the first flow sensor; and
connecting the sensor relay to a second flow sensor.

11. The method of claim 10, wherein the first flow sensor is a different model than the second flow sensor.

12. The method of claim 10, wherein the first flow sensor is a different type than the second flow sensor.

13. The method of claim 8, wherein wirelessly transmitting the signal includes wirelessly transmitting the signal using long range (LoRa) protocol.

14. The method of claim 8, the memory includes a memory cache, and further comprising clearing the memory cache after wirelessly transmitting the signal.

15. The method of claim 8, wherein wirelessly transmitting the signal includes wirelessly transmitting the signal when the signal exceeds a threshold signal.

16. The method of claim 8, further comprising transitioning from a hibernation mode to a transmission mode when the signal exceeds a threshold signal.

17. The method of claim 16, wherein wirelessly transmitting the signal includes wirelessly transmitting the signal while in the transmission mode.

18. The method of claim 16, wherein the threshold signal is associated with a flow rate associated with a leak at a valve upstream of the flow sensor.

19. The method of claim 18, wherein the signal includes a plurality of signals, and wherein storing the signal includes storing the plurality of signals having the signal below the threshold signal, and wherein wirelessly transmitting the signal includes wirelessly transmitting the plurality of signals when at least one of the plurality of signals exceeds the threshold signal.

20. A method for monitoring a flow sensor installed in an irrigation system, the method comprising:
installing a sensor relay to the flow sensor by connecting sensor leads of the flow sensor to relay leads of the sensor relay, wherein the sensor leads are configured to connect to a plurality of different flow sensors, wherein the sensor relay is powered by an independent power source;
receiving a plurality of signals from the flow sensor, wherein the plurality of signals are associated with a rotational rate of a paddle of the flow sensor;
transitioning from a hibernation mode to a transmission mode;
storing the plurality of signals on memory at the sensor relay; and
while in the transmission mode and using long range (LoRa) protocol, wirelessly transmitting the plurality of signals to a remote computing device.
